(19) United States
(12) Patent Application Publication
(10) Pub. No.: US 2024/0018635 A1
(43) Pub. Date: Jan. 18, 2024

(54) USE OF A TITANIUM-FREE NICKEL-CHROMIUM-IRON-MOLYBDENUM ALLOY

(71) Applicant: VDM METALS INTERNATIONAL GMBH, Werdohl (DE)

(72) Inventors: Helena ALVES, Dortmund (DE); Julia BOTINHA, Hagen (DE); Martin WOLF, Dortmund (DE)

(73) Assignee: VDM METALS INTERNATIONAL GMBH, Werdohl (DE)

(21) Appl. No.: 18/038,835

(22) PCT Filed: Jan. 31, 2022
(86) PCT No.: PCT/DE2022/100082

§ 371 Date: May 25, 2023

(30) Foreign Application Priority Data
Feb. 4, 2021 (DE) 10 2021 102 590.7
Jan. 27, 2022 (DE) 10 2022 101 851.2

(51) Int. Cl. C22C 38/54; C22C 38/50; C22C 38/48; C22C 38/44; C22C 38/42; C22C 38/06; C22C 38/04; C22C 38/02; C22C 38/00; B23K 35/02; B23K 35/30; B33Y 70/00

(52) U.S. Cl. CPC C22C 38/54; C22C 38/50; C22C 38/48; C22C 38/44; C22C 38/42; C22C 38/06; C22C 38/04; C22C 38/02; C22C 38/002; C22C 38/001; B23K 35/0261; B23K 35/3066; B33Y 70/00; B23K 35/0255

(57) ABSTRACT

An alloy with the composition (in mass-%): C: max. 0.02%; S: max. 0.01%; N: max. 0.03%; Cr: 20.0-23.0%; Ni: 39.0-44.0%; Mn: 0.4-<1.0%; Si: 0.1-<0.5%; Mo: >4.0-<7.0%; Nb: max. 0.15%; Cu: >1.5-<2.5%; Al: 0.05-<0.3%; Co: max. 0.5%; B: 0.001-<0.005%; Mg: 0.005-<0.015%; Fe: the rest, as well as smelting related impurities, is further processed as an alloyed solid in the form of wire, strip, rod or powder via the molten phase and is used in the field of wet corrosion applications in the oil and gas as well as the chemical industry.

The invention relates to the use of a titanium-free nickel-chromium-iron-molybdenum alloy with high pitting and crevice corrosion resistance as well as high yield point and strength.

The alloy named Alloy 825 is a material with high corrosion resistance that is used in the oil and gas as well as the chemical industry. The alloy named Alloy 825 is marketed under the material number 2.4858 and has the following chemical composition: C≤0.05%, S≤0.03%, Cr 19.5-23.5%, Ni 38-460, Mn≤1.0%, Si≤0.5%, Mo 2.5-3.5%, Ti 0.6-1.2%, Cu 1.5-3.0%, Al≤0.2%, Fe the rest.

The alloy named Alloy 825 is a titanium-stabilized material, which means that the titanium addition is supposed to neutralize the harmful carbon in the material as much as possible. The alloy named Alloy 825 is used as a wet corrosion alloy in various industrial areas, which also include the oil and gas industry, and with a PREN of 30 it has an only moderate resistance to pitting and crevice corrosion, especially in marine applications. By the effective sum PREN, the person skilled in the art understands the pitting resistance equivalent number.

PREN=1×% Cr+3.3×% Mo

The PREN summarizes the alloying elements having positive effect on the pitting and crevice corrosion resistance in a material-specific index.

Heretofore, the Alloy 825 (ISO 18274: Ni8065) has not been widely known as a welding additive material or weld filler metal (FM), and is hardly used. The reason for this is the difficult processability, which is reflected in the fact that the weld metal often exhibits hot cracks in the form of solidification and remelting cracks. Especially in the critical applications of the oil and gas industry, these processing problems, which are inherent to the material, represent an exclusion criterion, which often leads to the situation in which an alternative weld filler metal is used instead of the FM 825, and specifically the weld filler metal FM 625 (ISO 18274: Ni6625). In contrast to the FM 825, however, the FM 625 has the following disadvantages:
1.) In comparison with FM 825, the FM 625 is very highly alloyed and contains at least 58.0% nickel, at least 8.0% molybdenum and at least 3.0% niobium. For welding of structural parts of Alloy 825, the FM 625 is therefore unnecessarily highly overalloyed as weld filler metal, whereby high costs arise and resources such as the rare element niobium, for example, are unnecessarily consumed.
2.) In comparison with FM 825, the weld metal from FM 625 is more difficult to rework mechanically during precision turning of buildup welds, for example, or during leveling of weld reinforcing beads, since it has a significantly greater hardness. Thus the hardness of FM 825 weld metals is no higher than 250 HV10, whereas the hardness of FM 625 weld metals is usually around 310 HV10.
3.) In the case of FM 625, the danger of undesirable gamma” or delta phase formation exists due to the alloying element niobium, especially during a heat treatment after welding (so-called post-weld heat treatment, PWHT) or during a hot forming, for example by inductive bending of buildup-welded tubes. Due to the formation of gamma” or delta phase, a drastic loss of the corrosion resistance and/or ductility also takes place.

Besides a relatively low PREN and a very poor weldability due to hot cracking, the FM 825 has a further disadvantage, and specifically titanium as an alloying element. During fusion welding, titanium can easily be oxidized in uncontrolled manner once the material exists as a liquid phase, and this may then lead to a depletion of the interstitial titanium in the weld metal—and thus to an undefined reduction of its stabilizing effect. Beyond that, the oxidization or nitrodization of titanium during welding may lead to the situation that the quality of a welded joint decreases significantly, in that the titanium oxide or titanium nitride particles generated and distributed in the weld metal reduce the strength, ductility and/or corrosion resistance of the weld metal.

The material described in DE 10 2014 002 402 A1, also known under the name Alloy 825 CTP, is used only in the product forms of sheet, strip, tube (longitudinally welded and seamless), bars or as forgings.

The cited publication discloses a titanium-free alloy having high pitting and crevice corrosion resistance as well as high yield point in the work-hardened condition, with (in weight percent)
C max. 0.02%
S max. 0.01%
N max. 0.03%
Cr 20.0-23.0%
Ni 39.0-44.0%
Mn 0.4-<1.0%
Si 0.1-<0.5%
Mo >4.0-<7.0%
Nb max. 0.15%
Cu >1.5-<2.5%
Al 0.05-<0.3%
Co max. 0.5%
B 0.001-<0.005%
Mg 0.005-<0.015%
Fe the rest,
as well as smelting related impurities.

A method for the manufacture of this alloy is further described, in which:
a) the alloy is melted openly in continuous or ingot casting,
b) a homogenization annealing of the produced slabs/billets is carried out at 1150-1300° C. for 15 h to 25 h to eliminate the segregations caused by the increased molybdenum content, wherein
c) the homogenization annealing is carried out in particular following a first hot forming.

The material described in the foregoing (Alloy 825 CTP) has a higher PREN of approximately 42 compared to Alloy 825 and is not titanium-alloyed. The material named Alloy 825 CTP was developed to overcome the following disadvantages of the Alloy 825:
1.) poor meltability and castability due to Ti content (keyword: clogging)
2.) undesired TiC or Ti (C, N) precipitates in the microstructure
3.) not seawater-resistant/relatively poor pitting and crevice corrosion resistance.

The objective of the invention is to provide a new area of application for the material described in DE 10 2014 002 402 A1.

This objective is accomplished by the use of a titanium-free alloy with the following composition (in mass-o):
C max. 0.02%
S max. 0.01%
N max. 0.03%
Cr 20.0-23.0%
Ni 39.0-44.0%
Mn 0.4-<1.0%
Si 0.1-<0.5%
Mo >4.0-<7.0%
Nb max. 0.15%
Cu >1.5-<2.5%
Al 0.05-<0.3%
Co max. 0.5%
B 0.001-<0.005%
Mg 0.005-<0.015%
Fe the rest,
as well as smelting related impurities,
which is further processed as an alloyed solid in the form of wire, strip, rod or powder via the molten phase and is used in the field of wet corrosion applications in the oil and gas as well as the chemical industry.

Advantageous further developments of the subject matter of the invention can be inferred from the dependent claims

The suitability of the Alloy 825 CTP as a weld filler metal is not described in DE 10 2014 002 402 A1 and the product forms of welding wire, welding strip and powder (for additive manufacturing, for example) are not mentioned. The new area of application is characterized in that the material is basically processed via the molten phase.

The element carbon is present as follows in the alloy:
max. 0.02%

Alternatively, carbon may be limited as follows:
max. 0.015%
max. 0.01%
<0.01%

The Chromium content lies between 20.0 and 23.0%. Preferably, Cr may be adjusted within the range of values as follows in the alloy:
20.0 to 22.0%
21.0 to 23.0%
20.5 to 22.5%
22.0 to 23.0%

The nickel content lies between 39.0 and 44.0%, wherein preferred ranges may be adjusted as follows:
39.0 to <42.0%
39.0 to <41.0%
39.0 to <40.0%

The molybdenum content lies between >4.0 and <7.0%, wherein here, depending on service area of the alloy, preferred molybdenum contents may be adjusted as follows:
>5.0 to <7.0%
>5.0 to <6.5%
>5.5 to <6.5%
>6.0 to <7.0%

The material may preferably be used for the following applications:
as wire-like or rod-like weld filler metal for the joint welding for the base metal Alloy 825 or Alloy 825 CTP,
as wire-like or rod-like weld filler metal for the joint welding for superaustenitic steels or nickel-base alloys,
for the application known as wire arc additive manufacturing (WAAM)—in other words, the manufacture of structural parts by means of arc-welding processes with the use of welding wire,
in the form of powder for the so-called plasma powder welding method,
in the form of powder for the so-called additive manufacturing printing method for the manufacture of structural parts,
in the form of strip for the so-called electroslag and/or submerged arc welding for buildup welding or joint welding,
in the form of powder for thermal spraying processes, such as flame spraying,
in the form of a coated rod electrode,
in the form of cored wire electrodes.

In performed hot cracking investigations, in welding tests and modeling considerations, it was surprisingly found that the hot cracking safety, i.e. the resistance of a material to the formation of solidification and remelting cracks during a molten processing of the above-mentioned material, is dramatically better than with welding wire FM 825.

The investigations by means of the Modified Varestraint Transvarestraint (MVT) hot cracking test reveal the advantages of the FM 825 CTP compared with the FM 825 due to the following result:

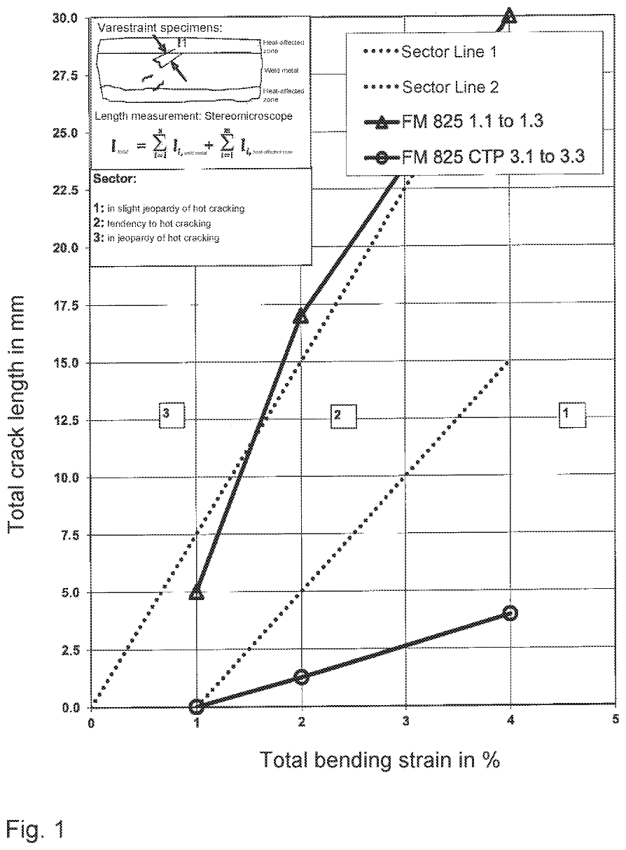

The MVT test is an externally stressed hot cracking test, with which specimens of the material FM 825 CTP material and specimens of the FM 825 were tested successively with an elongation energy of 7.5 kJ/cm and 14.5 kJ/cm at applied total bending strains of the respective specimens of 1%, 2% and 4%. The evaluation was based on the length of hot cracks located on the surface of the specimen in the weld metal and heat-affected zone after the test procedure. The values of the test series were then presented comparatively in a diagram, in which materials can basically be divided into three hot-cracking classes according to the determined test values (FIG. 1). Specimens of pure weld metal were used for the conducted investigations.

According to these MVT results, FM 825 welded with an elongation energy of 7.5 kJ/cm with the respective applied total bending strains of 1%, 2% and 4% lies, with the measured hot crack values (total hot crack length), in sector 2 with the interpretation “tendency to hot cracking” and in sector 3 with the interpretation “in jeopardy of hot cracking”. In the MVT tests conducted in the same way with the FM 825 CTP, all hot crack values (total hot crack lengths) lie in sector 1, which classifies the material as “safe from hot cracking”. Thus the MVT investigations show an unexpectedly good weldability in the form of the high hot cracking resistance of the FM 825 CTP.

The surprising results of the MVT investigations were checked, in that two plates of the Alloy 825 CTP with the batch number 130191 were welded together in the butt joint by means of the plasma welding method, wherein the following set of welding parameters was used: welding current=220 A, welding voltage=19.5 V, welding speed=30 cm/min, plasma gas flow rate=1 L/min, shielding gas flow rate=20 L/min, working distance=5 mm.

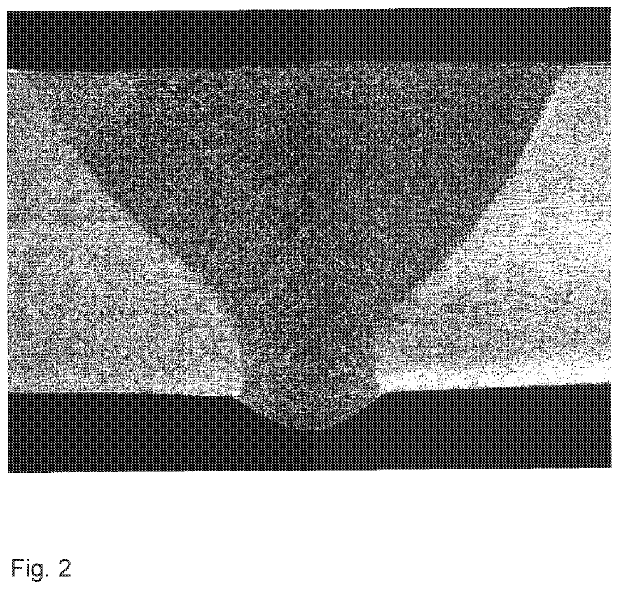

FIG. 2 shows a transverse macrosection of the welded joint. No hot cracks were found in the welded seam.

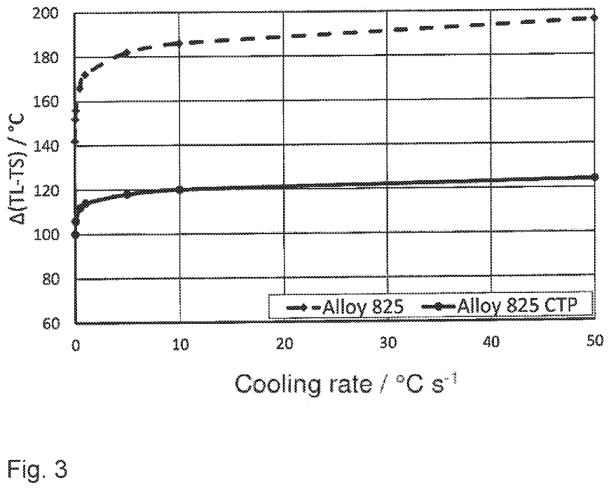

J-Mat Pro calculations were carried out for further investigation of the surprisingly good weldability. FIG. 3 shows a comparison of the solidification intervals of FM 825 CTP and of FM 825 as a function of the cooling rate. In the model, the solidification interval is an indicator of the hot-cracking susceptibility of a material and in the ideal case (for example, in the case of a pure material) is equal to 0. Since the cooling rate in welding varies greatly depending on method, structural part thickness, welding parameters, etc., the consideration not only of an individual cooling rate but also the consideration of a range of cooling rates from 0° C./s to 50° C./s is particularly informative. It is evident in FIG. 3 that a solidification interval lower by 40° C. to 70° C. was modeled for the FM 825 CTP than for the FM 825 in the entire investigated cooling rate range.

The Alloy 825 or FM 825 CTP has been melted in the following compositions:

| | Element in wt-% | | | | | | | | | | | | | | | |
|---|---|---|---|---|---|---|---|---|---|---|---|---|---|---|---|---|
| | | | | | | | | | | | | | | | Mg | Ca |
| | | | | | | | | | | | | | | | in | in |
| | C | S | N | Cr | Ni | Mn | Si | Mo | Ti | Nb | Cu | Fe | Al | B | ppm | ppm |
| Ref 825 | 0.002 | 0.0048 | 0.006 | 22.25 | 39.41 | 0.8 | 0.3 | 3.27 | 0.8 | 0.01 | 2 | R | 0.14 | 0 | — | — |
| LB2181 | 0.002 | 0.004 | 0.006 | 22.57 | 39.76 | 0.8 | 0.3 | 3.27 | 0.4 | 0.01 | 2.1 | R | 0.12 | 0 | — | — |
| LB2182 | 0.006 | 0.003 | 0.052> | 22.46 | 39.71 | 0.8 | 0.3 | 3.27 | — | 0.01 | 2 | R | 0.11 | 0 | — | — |
| LB2183 | 0.002 | 0.004 | 0.094> | 22.65 | 39.61 | 0.8 | 0.3 | 3.28 | — | 0.01 | 1.9 | R | 0.1 | 0 | — | — |
| LB2218 | 0.005 | 0.0031 | 0.048 | 22.50 | 39.59 | 0.8 | 0.3 | 3.27 | — | 0.01 | 2 | R | 0.12 | 0.01 | 100 | — |
| LB2219 | 0.005 | 0.0021 | 0.043> | 22.71 | 39.99 | 0.8 | 0.3 | 4.00> | — | 0.01 | 2 | R | 0.10 | 0.01 | 100 | — |
| LB2220 | 0.004 | 0.00202 | 0.042> | 22.56 | 39.84 | 0.8 | 0.33 | 4.93> | — | 0.01 | 2 | R | 0.11 | 0 | 100 | — |
| LB2221 | 0.004 | 0.0022 | 0.038> | 22.43 | 39.66 | 0.8 | 0.3 | 3.74> | — | 0.01 | 1.9 | R | 0.11 | 0 | 10 | — |
| LB2222 | 0.003 | 0.0033 | 0.042> | 22.5 | 39.62 | 0.8 | 0.3 | 3.66> | — | 0.01 | 2 | R | 0.18 | 0 | 20 | — |
| LB2223 | 0.002 | 0.0036 | 0.041> | 22.4 | 39.78 | 0.7 | 0.3 | 3.65> | — | 0.01 | 2.00 | R | 0.27> | 0 | 20 | — |
| LB2234 | 0.003 | 0.005 | 0.007 | 22.57 | 39.77 | 0.8 | 0.3 | 3.26 | — | 0.01 | 2.1 | R | 0.15 | 0 | 80 | 10 |
| LB2235 | 0.003 | 0.0034 | 0.006 | 22.56 | 39.67 | 0.8 | 0.3 | 3.28 | — | 0.01 | 2.1 | R | 0.12 | 0 | 150 | 12 |
| LB2236 | 0.002 | 0.004 | 0.006 | 22.34 | 39.46 | 0.8 | 0.3 | 3.27 | — | 0.01 | 2 | R | 0.11 | 0 | 30 | 42 |
| LB2317 | 0.001 | 0.0025 | 0.030 | 22.48 | 40.09 | 0.8 | 0.3 | 4.21 | — | 0.01( | 2 | R | 0.16 | 0 | 100 | 5 |
| LB2318 | 0.002 | 0.0036 | 0.038> | 22.76 | 39.77 | 0.8 | 0.3 | 5.20> | — | 0.01 | 2.1 | R | 0.15 | 0 | 100 | 4 |
| LB2319 | 0.002( | 0.0039 | 0.043> | 22.93> | 39.79 | 0.8 | 0.3 | 6.06 | — | 0.01 | 2.2 | R | 0.12 | 0 | 100 | 3 |
| LB2321 | 0.002 | 0.0051 | 0.040> | 22.56 | 40.23> | 0.7 | 0.3 | 6.23 | — | 0.01 | 2.1 | R | 0.10 | 0 | 100 | 4 |
| 132490 | 0.002 | 0.002 | 0.015 | 22.39 | 39.37 | 0.69 | 0.26 | 5.76 | — | 0.02 | 2.02 | R | 0.11 | 0.002 | 90 | — |
| 130191 | 0.005 | 0.002 | 0.032 | 22.28 | 39.19 | 0.71 | 0.27 | 5.88 | 0.06 | 0.02 | 2.05 | R | 0.09 | 0.002 | 110 | 100 |
| 169801 | 0.012 | 0.002 | 0.013 | 22.53 | 39.36 | 0.75 | 0.22 | 5.67 | 0.07 | 0.03 | 1.92 | R | 0.11 | 0.002 | 140 | 100 |
| 121253 | 0.010 | 0.002 | 0.031 | 22.31 | 39.19 | 0.65 | 0.30 | 5.66 | 0.07 | 0.02 | 1.95 | R | 0.18 | 0.002 | 80 | 100 |
| 119829 | 0.004 | 0.002 | 0.023 | 22.39 | 39.98 | 0.76 | 0.25 | 5.64 | 0.06 | 0.09 | 1.96 | R | 0.14 | 0.002 | 80 | 100 |
| 133253 | 0.005 | 0.002 | 0.222 | 26.69 | 31.49 | 1.44 | 0.01 | 6.46 | 0.01 | 0.01 | 1.21 | R | 0.07 | 0.002 | 20 | 100 |
| 116616 | 0.005 | 0.002 | 0.029 | 22.59 | 39.28 | 0.69 | 0.26 | 5.66 | 0.07 | 0.03 | 2.10 | R | 0.11 | 0.003 | 80 | 100 |

The material FM 825 CTP has been melted on a large scale as weld filler metal and has been further processed to weld filler metal, among other alternatives as welding wire with a diameter of 1.00 mm.

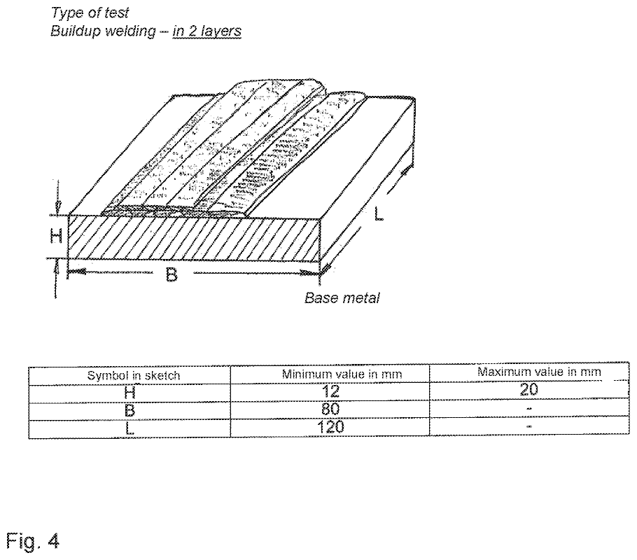

With the wire of the batch 132490, fully mechanized buildup welds were executed on S 355 carbon steel by means of the metal inert gas welding process (MIG method) using the pulsed arc, as illustrated in principle in FIG. 4. The following were used as the welding parameter: welding current=170 A, welding voltage=24 V, wire speed=7.4 m/min, welding speed=55 cm/min, and pure argon was used as shielding gas. The buildup welding was executed partly in 2 layers. It was shown both by means of visual inspection and by means of dye penetrant inspection that neither macroscopic nor microscopic hot cracks could be detected on the weld metal surface.

The results prove the following new findings:
the FM 825 CTP may be used for the buildup welding, for example for the ends of mechanically clad pipes,
the FM 825 CTP may be used as a joint welding material for the joining of Alloy 825 and/or Alloy 825 CTP structural parts,
the FM 825 CTP may be used as a material for the shape-imparting buildup welding (WAAM) and in the process is more easily reprocessable than corresponding additive-manufactured structural parts of FM 625, for example,
the FM 825 CTP may be used in the form of powder for the field of additive manufacturing and in the process may represent a more cost-effective, resource-saving and better mechanically post-processable alternative to FM 625,
in contrast to FM 825, the titanium in FM 825 CTP is not an alloying element. Therefore shielding gases containing nitrogen (proportions) are possible for the welding and/or printing instead of the otherwise used inert gases, which reduces manufacturing costs.

### LIST OF REFERENCE SYMBOLS

FIG. 1: MVT diagram with empirical sectors for evaluation of the hot cracking safety

FIG. 2: Metallographic transverse section of the plasma weld seam

FIG. 3: Solidification intervals of FM 825 CTP (Alloy 825 CTP) and FM 825 (Alloy 825) in comparison as a function of the cooling rate

FIG. 4: Schematic diagram of the test of weldability of FM 825 CTP by means of buildup welding

1. A method comprising:
providing an alloy with the composition (in mass-%)
C max. 0.02%
S max. 0.01%
N max. 0.03%
Cr 20.0-23.0%
Ni 39.0-44.0%
Mn 0.4-<1.0%
Si 0.1-<0.5%
Mo >4.0-<7.0%
Nb max. 0.15%
Cu >1.5-<2.5%
Al 0.05-<0.3%
Co max. 0.5%
B 0.001-<0.005%
Mg 0.005-<0.015%
Fe the rest,
as well as smelting related impurities,
further processing the alloy as an alloyed solid in the form of wire, strip, rod or powder via the molten phase and using the processed alloy in the field of wet corrosion applications in the oil and gas industry or the chemical industry.

2. The method according to claim 1 with the alloy having the composition (in mass-%)
C max. 0.015%
S max. 0.005%
N max. 0.02%
Cr 21.0-<23.0%
Ni >39.0-<43.0%
Mn 0.5-0.9%
Si 0.2-<0.5%
Mo >4.5-6.5%
Nb max. 0.15%
Cu >1.6-<2.3%
Al 0.06-<0.25%
Co max. 0.5%
B 0.002-0.004%
Mg 0.006-0.015%
Fe the rest,
as well as smelting related impurities.

3. The method according to claim 1 with the alloy having the composition (in mass-%)
C max. 0.010%
S max. 0.005%
N max. 0.02%
Cr 22.0-<23%
Ni >39.0-<43.0%
Mn 0.55-0.9%
Si 0.2-<0.5%
Mo >5.0-6.5%
Nb max. 0.15%
Cu >1.6-<2.2%
Al 0.06-<0.20%
Co max. 0.5%
B 0.002-0.004%
Mg 0.006-0.015%
Ti max. 0.10%
P max. 0.025%
W max. 0.50%
Fe min. 22%
as well as smelting related impurities.

4. The method according to claim 1, wherein the material is used as wire-like or rod-like weld filler metal for the buildup welding by means of arc or laser process.

5. The method according to claim 1, wherein the material is used as wire-like or rod-like weld filler metal for the joint welding for base metals, such as Alloy 825 or Alloy 825 CTP.

6. The method according to claim 1, wherein the material is used as wire-like or rod-like weld filler metal for the joint welding for superaustenitic steels and/or nickel-base alloys.

7. The method according to claim 1, wherein the material is processed by means of additive manufacturing by the arc, laser or electron beam welding process with the use of welding wire.

8. The method according to claim 1, wherein the material is used in the form of powder for the so-called plasma powder welding method.

9. The method according to claim 1, wherein the material is used in the form of powder for so-called additive manufacturing printing method for the manufacture of structural parts.

10. The method according to claim 1, wherein the material is used in the form of strip for the so-called electroslag and/or submerged arc welding for buildup welding or for joint welding.

11. The method according to claim 1, wherein the material is used in the form of powder for thermal spraying processes, especially the flame spraying.

12. The method according to claim 1, wherein the material is used in the form of a coated rod electrode.

13. The method according to claim 1, wherein the material is used in the form of cored wire electrodes.
